(19) United States
(12) Patent Application Publication
(10) Pub. No.: US 2020/0374771 A1
(43) Pub. Date: Nov. 26, 2020

(54) WIRELESS DEVICE, BASE STATION, TERMINAL DEVICE, WIRELESS COMMUNICATION SYSTEM, AND COMMUNICATION METHOD

(71) Applicant: FUJITSU LIMITED, Kawasaki-shi (JP)

(72) Inventor: AKIRA HIRATA, Yokohama (JP)

(73) Assignee: FUJITSU LIMITED, Kawasaki-shi (JP)

(21) Appl. No.: 16/990,501

(22) Filed: Aug. 11, 2020

Related U.S. Application Data
(63) Continuation of application No. PCT/JP2018/005336, filed on Feb. 15, 2018.

(51) Int. Cl. H04W 36/08; H04W 36/30; H04W 36/04; H04W 36/00

(52) U.S. Cl. CPC H04W 36/08; H04W 36/0055; H04W 36/04; H04W 36/30

(57) ABSTRACT

A wireless device includes a wireless unit and a handover processing unit. The wireless unit transmits a radio signal including first information to identify an own device in a cell managed by the wireless device. The handover processing unit performs processing related to handover, when receiving a handover instruction including second information to identify a cell from a wireless control device, with respect to a terminal device in the cell according to the second information included in the handover instruction.

### CROSS-REFERENCE TO RELATED APPLICATION

This application is a continuation of International Application No. PCT/JP2018/005336, filed on Feb. 15, 2018, the entire contents of which are incorporated herein by reference.

### FIELD

The embodiments discussed herein are related to a wireless device, a base station, a terminal device, a wireless communication system, and communication method.

### BACKGROUND

In a next generation mobile network, (for example, the fifth generation mobile networks (5G)), a base station is called next generation node B (gNB), and a cell formed by gNB is called new radio (NR) cell. Each gNB is identified by an identifier called gNB_ID, and each cell is identified by an identifier called NR cell identity (NCI). gNB_ID constitutes an upper-order bit of NCI (for example, refer to 3GPP TS 38.413 V0.5.0, 2017-12).

Moreover, in the next generation mobile network, to deal with the increase of message traffic, centralization and distribution of processing in a base station have been considered. As distribution of processing in a base station, for example, separation of a central unit (CU) and a distributed unit (DU) (hereinafter, denoted as “CU/DU separation”) is considered. In the CU/DU separation, message processing is divided per node by protocol hierarchy, and an upper layer protocol is processed by the CU, and a lower layer protocol is processed by the DU. In a base station, the CU and the DU can be combined by 1 to N combination, or N to 1 combination.

The DU forms a cell and performs wireless communication with a terminal device in the cell. Other than a case in which one DU forms one cell, there also are cases in which one DU forms multiple cells, or one cell is formed by multiple DUs. Moreover, in R3-173844, it is described that the identifier of a DU and an NCI are irrelevant values.

For example, when a long term evolution (LTE)-based handover process is applied to the next generation mobile network, if the identifier of the DU and the NCI are irrelevant values, for example, there are problems as described below.

In the LTE-based handover process, a terminal device first receives a radio signal transmitted from a target base station, and then transmits a measurement report (MR) message including information about the target base station collected from the received radio signal, to a source base station currently connected to. The information about the target base station includes, for example, gNB_ID, NCI, and the like. The source base station transmits HO REQUIRED including gNB_ID and NCI to a host device. The host device transmits HO REQUEST including NCI to a target base station corresponding to gNB_ID included in HO REQUIRED.

The target base station can identify a cell in which the handover process is to be performed, based on the HO REQUEST received from the host device. However, when the target base station has more than one DU, it is difficult for the CU of the target base station to identify a DU that manages the cell in which the handover process is to be performed. Accordingly, the CU of the target base station has a difficulty in determining which DU to be caused to perform the handover process. Therefore, handover of a terminal device to a DU that is separated from a CU is difficult.

### SUMMARY

According to an aspect of an embodiment, a wireless device is provided in a base station including a wireless control device and a wireless device. The wireless device includes a wireless unit and a handover processing unit. The wireless unit wirelessly transmits a signal including first information to identify an own device in a cell. The handover processing unit performs processing related to handover, when receiving a handover instruction including second information to identify the cell from the wireless control device, with respect to a terminal device in the cell according to the second information included in the handover instruction.

The object and advantages of the n will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a wireless communication system;

FIG. 2 illustrates an example of processing of the wireless communication system when user equipment (UE) performs handover;

FIG. 3 is a block diagram illustrating an example of a CU in a first embodiment;

FIG. 4 is an illustration of low layer split (LLS);

FIG. 5 illustrates an example of an identification (ID) table;

FIG. 6 is a block diagram illustrating an example of a DU in the first embodiment;

FIG. 7 is a block diagram illustrating an example of a UE;

FIG. 8 illustrates an example of processing of a gNB in the first embodiment;

FIG. 9 is an illustration of a high layer split (HLS);

FIG. 10 is a block diagram illustrating an example of a CU in a second embodiment;

FIG. 11 is a block diagram illustrating an example of a DU in the second embodiment;

FIG. 12 illustrates an example of processing of a gNB in the second embodiment;

FIG. 13 is a block diagram illustrating an example of a CU in a third embodiment;

FIG. 14 is a block diagram illustrating an example of a DU in the third embodiment;

FIG. 15 illustrates an example of processing of a gNB in the third embodiment;

FIG. 16 is a block diagram illustrating an example of a CU in a fourth embodiment;

FIG. 17 illustrates an example of processing of a gNB in the fourth embodiment;

FIG. 18 is a block diagram illustrating an example of a CU in a fifth embodiment;

FIG. 19 is a block diagram illustrating an example of a DU in the fifth embodiment;

FIG. 20 illustrates an example of processing of a gNB in the fifth embodiment;

FIG. 21 is a block diagram illustrating an example of a DU in a sixth embodiment;

FIG. 22 illustrates an example of processing of a gNB in the sixth embodiment;

FIG. 23 illustrates an example of hardware of a CU;

FIG. 24 illustrates an example of hardware of a DU; and

FIG. 25 illustrates an example of hardware of a UE.

### DESCRIPTION OF EMBODIMENTS

Preferred embodiments of the present invention will be explained with reference to accompanying drawings. The following embodiments are not intended to limit the disclosed techniques. Moreover, the respective embodiments can be combined appropriately within a range not causing a contradiction in the process.

### [a] First Embodiment

Wireless Communication System 10

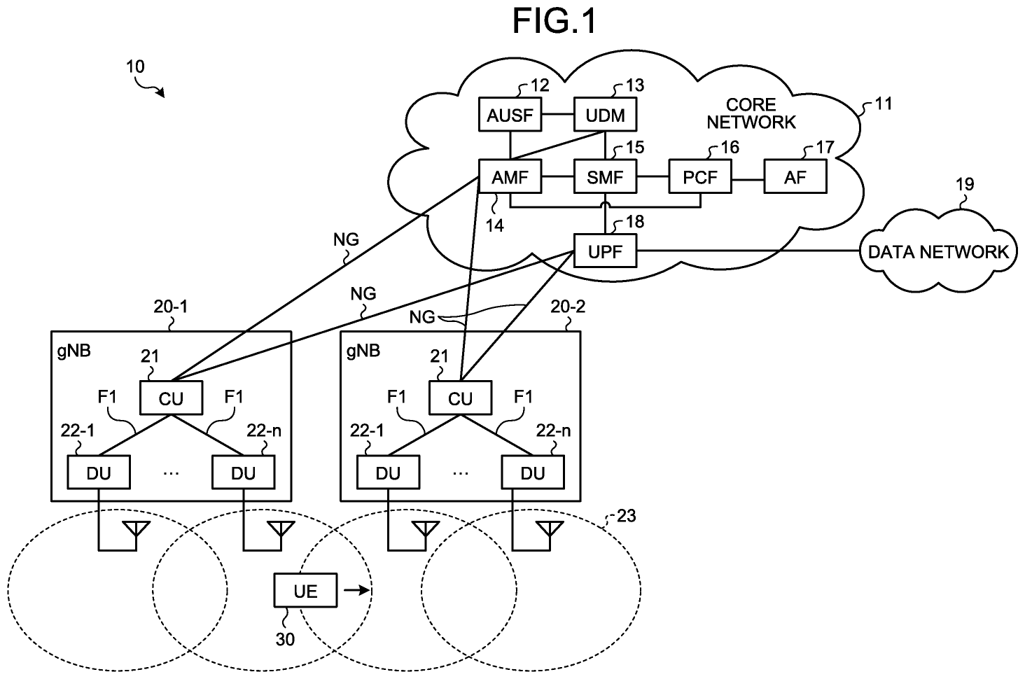

FIG. 1 illustrates an example of a wireless communication system 10. The wireless communication system 10 includes a core network 11, plural units of gNBs 20-1 and 20-2, and a UE 30. In the following description, the plural units of the gNB 20-1 and 20-2 are referred to as gNB 20 when they are not distinguished therebetween, but are collectively called. The respective gNBs 20 are connected to the core network 11, and control wireless communication of the UE 30, and relay communication between the UE 30 and the core network 11. The respective gNB 20 are one example of a base station, and the UE 30 is one example of a terminal device. Moreover, the gNB 20-1 is one example of a second base station, and the gNB 20-2 is one example of a first base station.

The core network 11 includes an authentication server function (AUSF) 12, a unified data management (UDM) 13, and an access and mobility management function (AMF) 14. Furthermore, the core network 11 includes a session management function (SMF) 15, a policy control function (PCF) 16, an application function (AF) 17, and a user plane function (UPF) 18. The UPF is connected to a data network 19. The AMF 14 and the UPF 18 are connected to the respective gNBs 20 through an NG interface. The AMF 14 and the UPF 18 are one example of a host device.

Each of the gNBs 20 includes a CU 21 and plural DUs 22-1 to 22-n. In the following description, the plural units of the DUs 22-1 and 22-n are referred to as DU 22 when they are not distinguished therebetween, but are collectively called. The CU 21 and the respective DUs 22 are connected to one another through an F1 interface. Note that the DU 22 included in each of the gNB 20 may be just one unit. Moreover, each of the gNBs 20 may include more than one unit of the CU 21.

The CU 21 performs processing related to C-Plane in an upper layer protocol of a wireless access, and performs processing related to U-Plane in a lower layer protocol of the wireless access. The DU 22 performs processing of a lower layer protocol in a wireless access. Furthermore, the DU 22 forms a cell 23 by a radio signal, and performs wireless communication with the UE 30 in the cell 23. The CU 21 is one example of a wireless control device, and the DU 22 is one example of a wireless device.

The UE 30 performs wireless communication in the cell 23 with the DU 22 that manages the cell 23. The UE 30 performs handover from the gNB 20-1 to the gNB 20-2, for example, when it moved from an area inside the cell 23 managed by the DU 22 of the gNB 20-1 to an area inside the cell 23 managed by the DU 22 of the gNB 20-2 from as indicated by an arrow in FIG. 1. In the following, handover may be described as HO.

Processing of Wireless Communication System 10 at HO

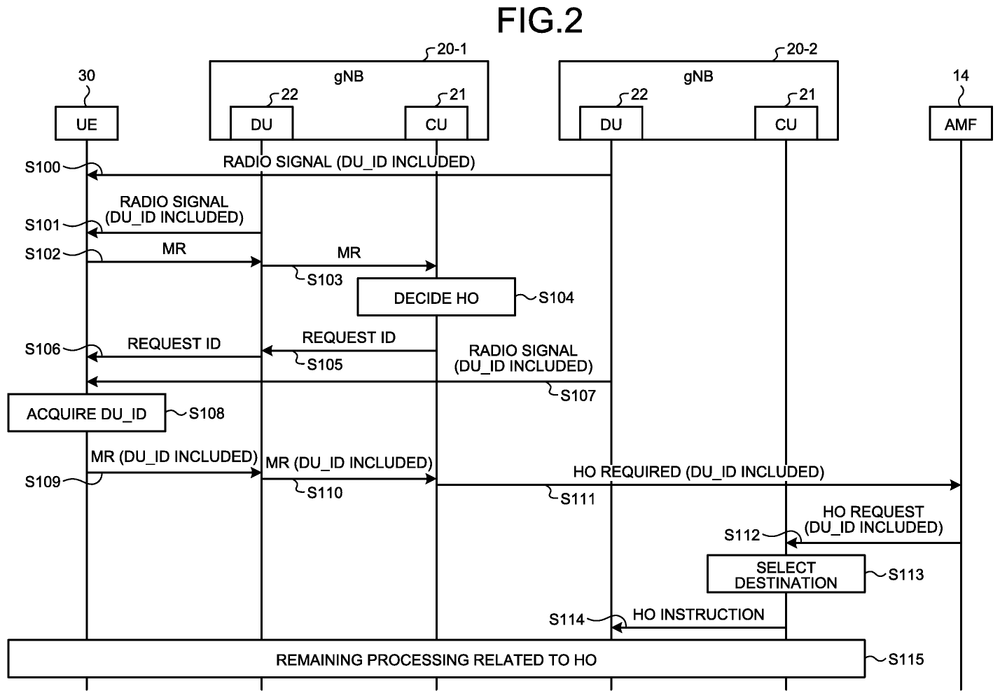

FIG. 2 illustrates an example of processing of the wireless communication system 10 when the UE 30 performs handover. FIG. 2 illustrates processing when the UE 30 belonging to the gNB 20-1 performs handover to the gNB 20-2. Note that belonging means a state in which at least wireless bearer of C-Plane is established, for example, between the UE 30 and the gNB 20. Moreover, FIG. 2 illustrates one of the DUs 22 included in the gNB 20 in each of the respective gNBs 20.

The DU 22 of the respective gNBs 20 transmits a radio signal including DU_ID, which is an identifier of the DU 22, and NCI to the cell 23 (S100, S101). DU_ID is one example of first information, and NCI is one example of second information. Having received the radio signal transmitted from the gNB 20-2, the UE 30 transmits an MR message including a reception power of the received radio signal and NCI, to the gNB 20-1 (S102).

The DU 22 of the gNB 20-1 transfers the MR message received from the UE 30 to the CU 21 (S103). The CU 21 of the gNB 20-1 determines whether the reception power included in the MR message transmitted from the UE 30 satisfies a condition of HO. When the condition of HO is satisfied, the CU 21 decides HO of the UE 30 (S104). The CU 21 then transmits an ID request message to request for DU_ID of the target gNB to be a destination of HO, to the DU 22 (S105). The DU 22 wirelessly transmits the ID request message transmitted from the CU 21 to the UE 30 (S106).

The UE 30 receives the ID request message transmitted from the DU 22 of the gNB 20-1. The UE 30 receives a radio signal transmitted from the gNB 20-2 (S107), and acquires DU_ID from the received radio signal (S108). The UE 30 then transmits the MR message further including DU_ID to the gNB 20-1 (S109).

The DU 22 of the gNB 20-1 transfers the MR message received from the UE 30 (S110). The CU 21 acquires DU_ID, NCI, and the like from the MR message transmitted from the UE 30. The CU 21 extracts gNB_ID of the target gNB from NCI. The CU 21 generates an HO REQUIRED message including gNB_ID, NCI, and DU_ID. The CU 21 then transmits the HO REQUIRED message to the AMF 14 through the NG interface (S111). HO REQUIRED is one example of a handover request message.

Having received the HO REQUIRED message, the AMF 14 acquires gNB_ID, NCI, DU_ID, and the like from the HO REQUIRED message. The AMF 14 generates an HO REQUEST message including NCI and DU_ID. The AMF 14 then transmits the HO REQUEST message to the gNB 20-2 corresponding to gNB_ID acquired from the HO REQUIRED message through the NG interface (S112).

Having received the HO REQUEST message, the CU 21 of the gNB 20-2 acquires NCI, DU_ID, and the like from the HO REQUEST message. The CU 21 then generates an HO instruction including NCI. The CU 21 selects the DU 22 corresponding to DU_ID as a destination of the HO instruction (S113). The CU 21 transmits the HO instruction to the selected DU 22 (S114). Thereafter, remaining processing related to HO is performed by the AMF 14, the respective gNBs 20, and the UE 30 (S115). The remaining processing related to HO is similar to processing in conventional HO and, therefore, detailed explanation thereof is omitted. Thus, the UE 30 can perform handover to the DU 22 separated from the CU 21.

CU 21

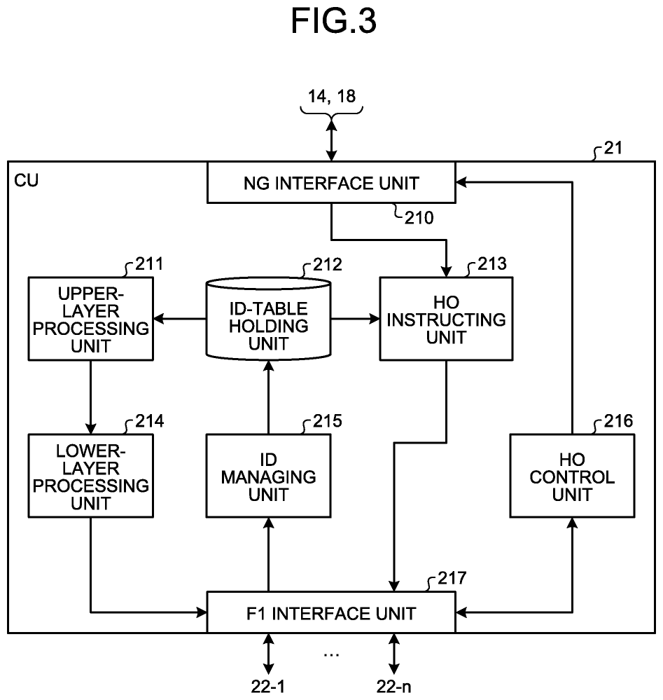

FIG. 3 is a block diagram illustrating an example of the CU 21 in a first embodiment. The CU 21 includes an NG interface unit 210, an upper-layer processing unit 211, an ID-table holding unit 212, an HO instructing unit 213, a lower-layer processing unit 214, an ID managing unit 215, an HO control unit 216, and an F1 interface unit 217.

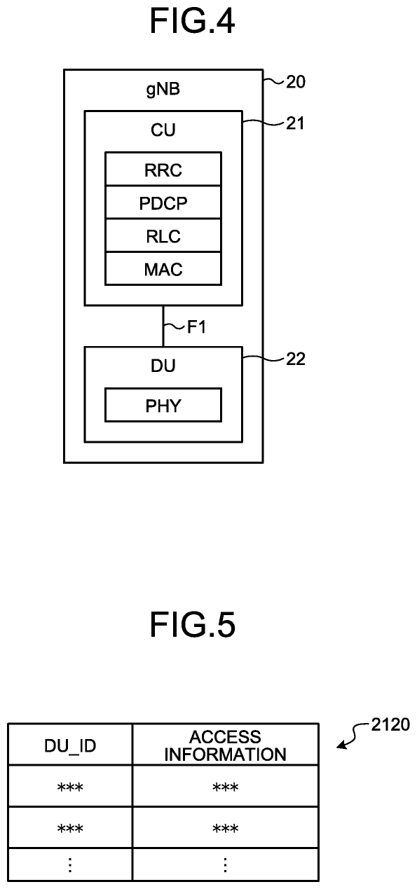

In the present embodiment, hierarchy of protocol processed by the gNB 20 is divided into two by LLS, and an upper layer protocol is processed by the CU 21, and a lower layer protocol is processed by the DU 22. FIG. 4 is an illustration of the LLS. In the present embodiment, the CU 21 processes an RRC layer, a PDCP layer, an RLC layer, and a MAC layer. Moreover, the DU 22 processes a PHY layer. PRC is an abbreviation for radio resource control, PDCP is an abbreviation for packet data convergence protocol, RLC is an abbreviation for radio link control, MAC is an abbreviation for media access control, and PHY is an abbreviation for physical. The RRC layer is one example of a wireless control layer.

The NG interface unit 210 establishes an NG interface between the AMF 14 and the UPF 18, and performs communication with the AMF 14 and the UPF 18 through the NG interface. The F1 interface unit 217 establishes an F1 interface between itself and each of the DUs 22, and performs communication with each of the DU 22 through the F1 interface.

The ID managing unit 215 issues DU_ID with respect to the DU 22, when the F1 interface is established between itself and each of the DUs 22 by the F1 interface unit 217, for each of the DUs 22. The ID managing unit 215 enters the issued DU_ID in an ID table 2120 in the ID-table holding unit 212, associating with information to access the DU 22.

The ID-table holding unit 212 holds the ID table 2120, for example, as illustrated in FIG. 5. FIG. 5 illustrates an example of the ID table 2120. In the ID table 2120, access information to access the DU 22 that is identified by DU_ID is stored, associating with corresponding DU_ID. The access information is, for example, an address in the network to connect the CU 21 and the respective DU 22.

The upper-layer processing unit 211 acquires DU_ID unique to the DU 22 from the ID table 2120 in the ID-table holding unit 212, for each of the DUs 22. The upper-layer processing unit 211 generates a signal of an upper layer signal in which DU_ID is set, for each of the DUs 22. In the present embodiment, the upper layer is, for example, the RRC layer. The upper-layer processing unit 211 outputs the generated signal of an upper layer to the lower-layer processing unit 214, for each of the DUs 22.

The lower-layer processing unit 214 performs processing of a lower layer with respect to the signal of an upper layer output from the upper-layer processing unit 211. In the present embodiment, the lower layer is, for example, the PDCP layer, the RLC layer, and the MAC layer. The lower-layer processing unit 214 outputs the signal subjected to processing of the MAC layer to the F1 interface unit 217, for each of the DUs 22. The F1 interface unit 217 transmits the signal output from the lower-layer processing unit 214 to the corresponding DU 22.

When the HO control unit 216 receives an MR message from the DU 22 through the F1 interface unit 217, the HO control unit 216 determines whether the condition of HO is satisfied based on a reception power included in the MR message. When the condition of HO is satisfied, the HO control unit 216 decides HO of the UE 30. The HO control unit 216 then generates an ID request message to request for DU_ID of the target gNB to be a destination of HO. The HO control unit 216 transmits the generated ID request message to the DU 22 of the source of the MR message through the F1 interface unit 217.

Furthermore, when the HO control unit 216 receives the MR message including DU_ID from the DU 22 through the F1 interface unit 217, the HO control unit 216 acquires DU_ID, NCI, and the like from the MR message. The HO control unit 216 extracts gNB_ID of the target gNB from NCI. The HO control unit 216 then generates a HO REQUIRED message including gNB_ID, NCI, and DU_ID. The HO control unit 216 transmits the generated HO REQUIRED message to the AMF 14 through the NG interface unit 210.

When the HO instructing unit 213 receives the HO REQUEST message from the AMF 14 through the NG interface unit 210, the HO instructing unit 213 acquires NCI, DU_ID, and the like from the HO REQUEST message. The HO instructing unit 213 then generates an HO instruction including NCI. The HO instructing unit 213 refers to the ID table 2120 in the ID table holding unit 212, and selects the DU 22 that corresponds to access information corresponding to DU_ID as a destination of the HO instruction. The HO instructing unit 213 transmits the HO instruction to the selected DU 22 through the F1 interface unit 217.

DU 22

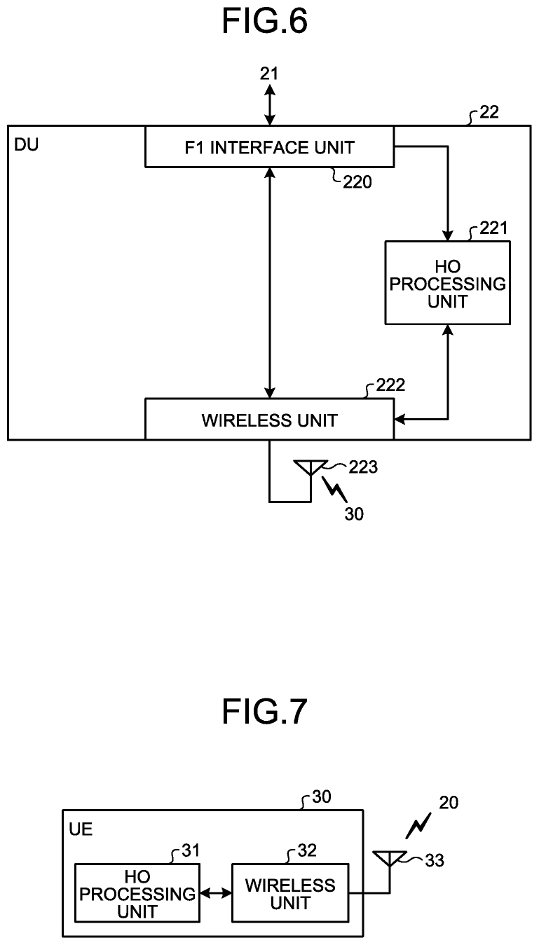

FIG. 6 is a block diagram illustrating an example of the DU 22 in the first embodiment. The DU 22 includes an F1 interface unit 220, an HO processing unit 221, a wireless unit 222, and an antenna 223. The F1 interface unit 220 establishes the F1 interface between itself and the CU 21, and performs communication with the CU 21 through the F1 interface. The F1 interface unit 220 is one example of a signal receiving unit.

The wireless unit 222 forms the cell 23 in a range in which radio signals reach, by transmitting radio signals through the antenna 223. Moreover, the wireless unit 222 performs processing of the PHY layer with respect to a signal received from the CU 21 through the F1 interface unit 220. The wireless unit 222 transmits the signal subjected to the processing of the PHY layer to the cell 23 through the antenna 223. Furthermore, the wireless unit 222 performs processing of the PHY layer with respect to a radio signal received from the UE 30 in the cell 23 through the antenna 223. The wireless unit 222 transmits the signal subjected to the processing of the PHY layer to the CU 21 through the F1 interface unit 220.

When receiving the HO instruction from the CU 21 through the F1 interface unit 220, the HO processing unit 221 performs processing related to handover between itself and the UE 30 in the cell 23 identified by NCI included in the HO instruction through the wireless unit 222 and the antenna 223. For example, the HO processing unit 221 performs processing indicated in S115 in FIG. 2. Specifically, processing of waiting for a signal from the UE 30 subject to handover, processing of transmitting a message relating to handover, and the like are performed.

UE 30

FIG. 7 is a block diagram illustrating an example of the UE 30. The UE 30 includes an HO processing unit 31, a wireless unit 32, and an antenna 33.

The wireless unit 32 receives a radio signal transmitted from the DU 22, and performs processing of down conversion, decoding, and the like with respect to the received radio signal. The radio signal transmitted from the DU 22 includes DU_ID of the DU 22. The wireless unit 32 outputs a signal subjected to the processing to the HO processing unit 31. Moreover, the wireless unit 32 performs processing of encoding, up conversion, and the like with respect to a signal output from the HO processing unit 31. The wireless unit 32 then transmits the signal subjected to the processing to the DU 22 through the antenna 33. The wireless unit 32 is one example of a transmitting unit and a receiving unit.

The HO processing unit 31 measures a reception power of a radio signal transmitted from the peripheral DU 22 based on the signal received by the wireless unit 32. Moreover, the HO processing unit 31 acquires NCI, and the like of the peripheral DU 22 from the signal received by the wireless unit 32. The HO processing unit 31 generates an MR message including the reception power and NCI, and outputs the generated MR message to the wireless unit 32. The MR message is converted into a radio signal by the wireless unit 32, and is transmitted to the belonging DU 22 through the antenna 33.

Furthermore, when the signal received by the wireless unit 32 is an ID request, the HO processing unit 31 further acquires DU_ID of the peripheral DU 22 from the signal received by the wireless unit 32. The HO processing unit 31 generates an MR message further including DU_ID, and outputs the generated MR message to the wireless unit 32. The MR message further including DU_ID is converted into a radio signal by the wireless unit 32, and is transmitted to the belonging DU 22 through the antenna 33.

Processing of gNB 20

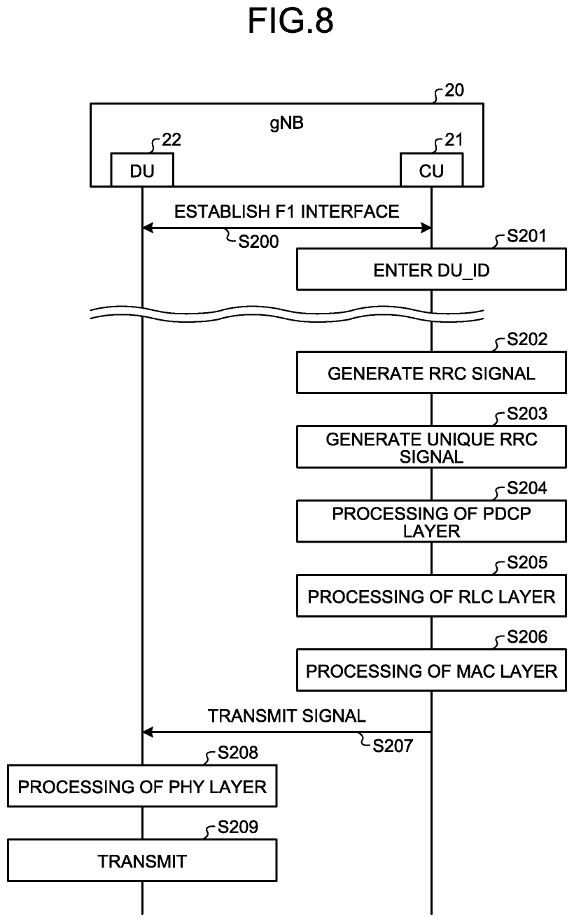

FIG. 8 illustrates an example of processing of the gNB 20 in the first embodiment. FIG. 8 mainly illustrates processing of transmitting a radio signal including DU_ID, out of processing of the gNB 20. Although FIG. 8 illustrates processing regarding one DU 22 out of the DUs 22 in the gNB 20, processing of the other DUs 22 in the gNB 20 is also similar processing.

First, the F1 interface unit 217 of the CU 21 and the F1 interface unit 220 of the DU 22 perform processing to establish an F1 interface (S200). Thus, the CU 21 and the DU 22 are enabled to communicate with each other through the F1 interface. The ID managing unit 215 of the CU 21 issues DU_ID to the DU 22, and enters the issued DU_ID in the ID table 2120 in the ID-table holding unit 212, associating with access information to access the DU 22 (S201).

Next, when transmitting a radio signal to the cell 23, the upper-layer processing unit 211 of the CU 21 generates an RRC signal, which is a signal of the RRC layer (S202). Moreover, the upper-layer processing unit 211 acquires DU_ID unique to the DU 22 of the destination of the RRC signal from the ID table 2120 in the ID-table holding unit 212. The upper-layer processing unit 211 generates a unique RRC signal that is an RRC signal including DU_ID (S203). The upper-layer processing unit 211 then outputs the generated RRC signal and unique RRC signal to the lower-layer processing unit 214.

Next, the lower-layer processing unit 214 of the CU 21 performs processing of the PDCP layer with respect to the RRC signal and the unique RRC signal output from the upper-layer processing unit 211 (S204). In the PDCP layer, processing of concealment, correctness verification, sorting, header compression, and the like is performed.

Next, the lower-layer processing unit 214 performs processing of the RLC layer with respect to the signal subjected to the processing of the PDCP layer (S205). In the RLC layer, processing of retransmission control, and the like is performed.

Next, the lower-layer processing unit 214 performs processing of the MAC layer with respect to the signal subjected to the processing of the RLC layer (S206). In the MAC layer, processing of mapping of data to a wireless resource, and the like is performed. The lower-layer processing unit 214 then outputs the signal subjected to the processing of the MAC layer to the F1 interface unit 217. The F1 interface unit 217 transmits a signal output from the lower-layer processing unit 214 to the DU 22 corresponding to DU_ID through the F1 interface (S207).

The F1 interface unit 220 of the DU 22 outputs the signal received from the CU 21 to the wireless unit 222. The wireless unit 222 performs processing of the PHY layer with respect to the signal transmitted from the CU 21 (208). In the PHY layer, processing of encoding, modulation, and the like is performed. The wireless unit 222 then transmits the signal subjected to the processing of the PHY layer as a radio signal from the antenna 223 (S209).

### Effect of First Embodiment

As above, the first embodiment has been described. As described above, the wireless communication system 10 of the present embodiment includes the gNB 20 and the UE 30. The gNB 20 includes the CU 21 and the DU 22. The DU 22 includes the HO processing unit 221 and the wireless unit 222. The wireless unit 222 wirelessly transmits a signal including DU_ID to the cell 23 managed by the DU 22. When receiving an HO instruction including NCI from the CU 21, the HO processing unit 221 performs processing related to handover between itself and the UE 30 in the cell 23 according to NCI included in the HO instruction through the wireless unit 222. The CU 21 includes the HO instructing unit 213. When receiving HO REQUIRED including NCI and DU_ID from the AMF 14, the HO instructing unit 213 transmits an HO instruction including NCI that is included in HO REQUIRED to the DU 22 identified by DU_ID included in HO REQUIRED. The UE 30 includes the HO processing unit 31 and the wireless unit 32. The wireless unit 32 receives a radio signal transmitted from the gNB 20. The HO processing unit 31 acquires DU_ID from the radio signal received by the wireless unit 32. Moreover, the wireless unit 32 transmits information regarding the peripheral gNB 20 including DU_ID to another gNB 20. Thus, the UE 30 can perform handover to the gNB 20 including the UD 22 separated from the CU 21.

Moreover, the DU 22 of the present embodiment further includes the F1 interface unit 220 that receives a signal generated by the CU 21 and including a signal of the RRC layer in which DU_ID is set. The wireless unit 222 transmits a radio signal based on the signal received by the F1 interface unit 220. Thus, the DU 22 can transmit a radio signal including DU_ID.

### [b] Second Embodiment

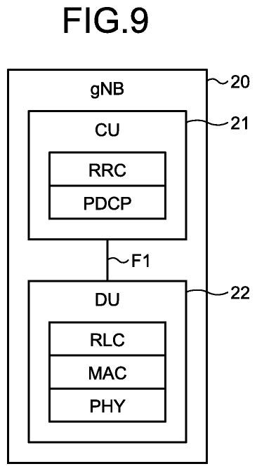

In the first embodiment described above, the hierarchy of protocol processed by the gNB 20 is divided into two by LLS. On the other hand, in a second embodiment, a hierarchy of protocol processed in the gNB 20 is divided into two by HLS. FIG. 9 is an illustration of HLS. In the present embodiment, the CU 21 processes the RRC layer and the PDCP layer, and the DU 22 processes the RLC layer, the MAC layer, and the PHY layer.

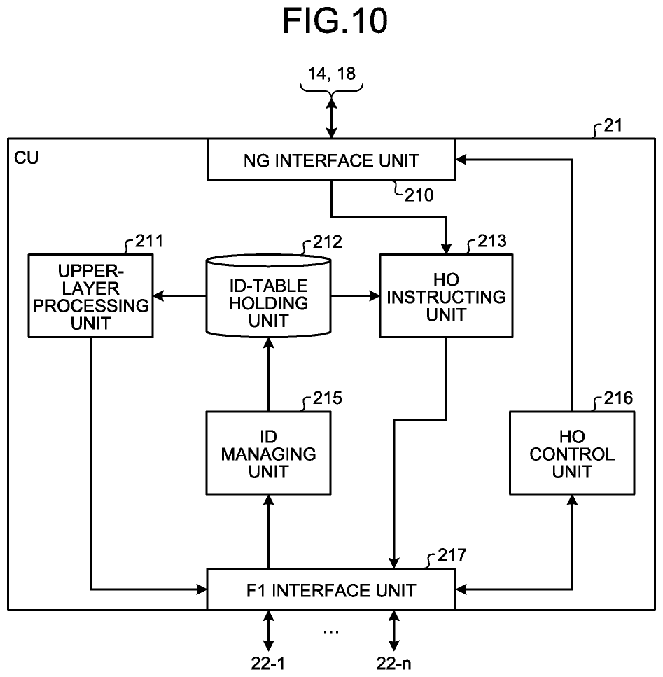

CU 21 FIG. 10 is a block diagram illustrating an example of the CU 21 in the second embodiment. The CU 21 includes the NG interface unit 210, the upper-layer processing unit 211, the ID-table holding unit 212, the HO instructing unit 213, the ID managing unit 215, the HO control unit 216, and the F1 interface unit 217. In FIG. 10, blocks to which reference symbols identical to FIG. 3 are assigned are similar to the blocks explained in FIG. 3 except a point explained below and, therefore explanation thereof is omitted.

The upper-layer processing unit 211 generates an RRC signal and a unique RRC signal for each of the DUs 22, and performs processing of the PDCP layer with respect to the RRC signal and the unique RRC signal. The upper-layer processing unit 211 then outputs the signal subjected to the processing of the PDCP layer to the F1 interface unit 217. The F1 interface unit 217 transmits the signal output from the upper-layer processing unit 211 to the corresponding DU 22.

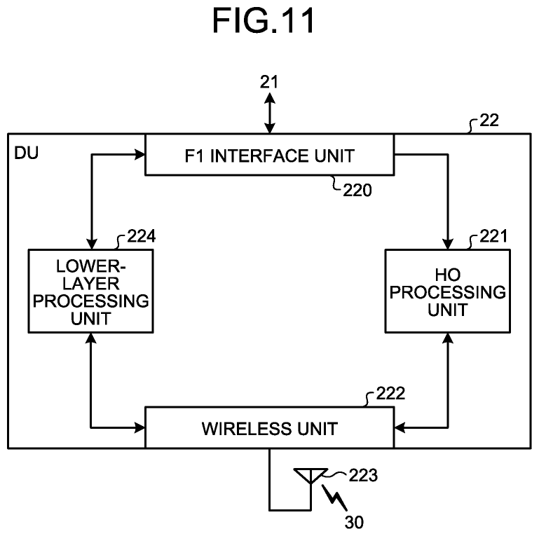

DU 22 FIG. 11 is a block diagram illustrating an example of the DU 22 in the second embodiment. The DU 22 includes the F1 interface unit 220, the HO processing unit 221, the wireless unit 222, the antenna 223, and a lower-layer processing unit 224. In FIG. 11, blocks to which reference symbols identical to FIG. 6 are assigned are similar to the blocks explained in FIG. 6 except a point explained below and, therefore explanation thereof is omitted.

The F1 interface unit 220 outputs the signal received and subjected to the processing of the PDCP layer to the lower-layer processing unit 224. The signal subjected to the processing of the PDCP layer is one example of a signal in which DU_ID is set to a signal of a wireless control layer. The lower-layer processing unit 224 performs processing of a lower layer with respect to the signal received from the CU 21 through the F1 interface unit 220. In the present embodiment, the lower layer is, for example, the RLC layer and the MAC layer. The lower-layer processing unit 224 outputs the signal subjected to the processing of the MAC layer to the wireless unit 222. The wireless unit 222 performs processing of the PHY layer with respect to the signal output from the lower-layer processing unit 224. The wireless unit 222 then transmits the signal subjected to the PHY layer to the cell 23 through the antenna 223.

Processing of gNB 20

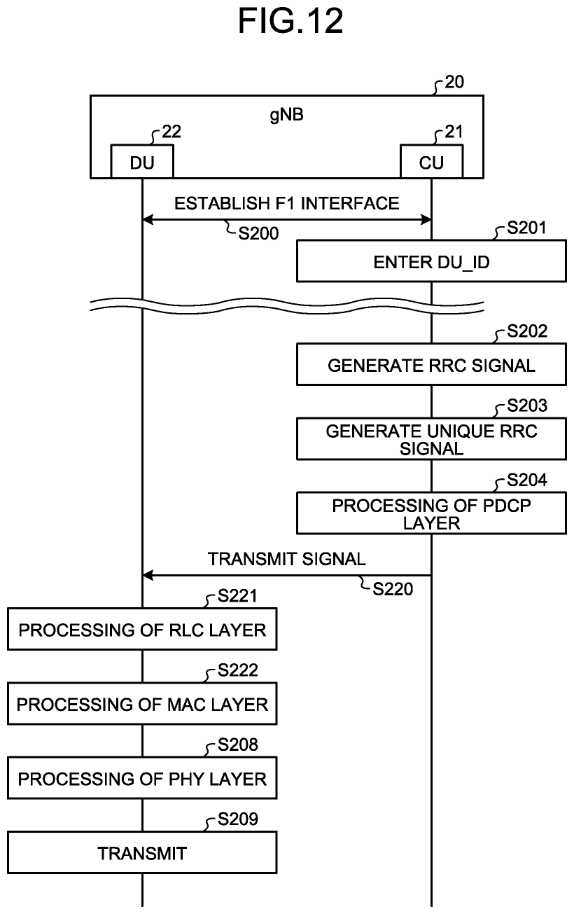

FIG. 12 illustrates an example of processing of the gNB 20 in the second embodiment. FIG. 12 mainly illustrates processing of transmitting a radio signal including DU_ID, out of processing of the gNB 20. In FIG. 12, processing to which reference symbols identical to FIG. 8 are assigned is similar to the processing explained in FIG. 8 except a point explained below and, therefore, explanation thereof is omitted.

The upper-layer processing unit 211 of the CU 21 generates an RRC signal and a unique RRC signal (S202, S203). The upper-layer processing unit 211 performs processing of the PDCP layer with respect to the RRC signal and the unique RRC signal (S204). The upper-layer processing unit 211 then outputs the signal subjected to the processing of the PDCP layer to the F1 interface unit 217. The F1 interface unit 217 transmits the signal output from the upper-layer processing unit 211 to the DU 22 corresponding to DU_ID through the F1 interface (S220).

The F1 interface unit 220 of the DU 22 outputs the signal received from the CU 21 and subjected to the processing of the PDCP layer to the lower-layer processing unit 224. The lower-layer processing unit 224 performs processing of the RLC layer with respect to the signal subjected to the processing of the PDCP layer (S221). The lower-layer processing unit 224 performs processing of the MAC layer with respect to the signal subjected to the processing of the RLC layer (S222). The lower-layer processing unit 224 then outputs the signal subjected to the processing of the MAC layer to the wireless unit 222. Thereafter, processing similar to the processing illustrated in FIG. 8 is performed.

### Effect of Second Embodiment

As above, the second embodiment has been described. As described above, the F1 interface unit 220 of the present embodiment receives a signal generated by the CU 21 and including a signal of the RRC layer in which DU_ID is set. Moreover, the lower-layer processing unit 224 performs processing of a layer lower than the RRC layer with respect to the signal received by the F1 interface unit 220. Furthermore, the wireless unit 22 transmits a radio signal based on the signal processed by the lower-layer processing unit 224. Thus, the DU 22 is enabled to transmit a radio signal including DU_ID.

### [c] Third Embodiment

In the first embodiment described above, a signal of an upper layer in which DU_ID is set is generated by the CU 21. On the other hand, in a third embodiment, a signal of an upper layer in which DU_ID is set is generated by the DU 22. In the third embodiment, a hierarchy of protocol processed in the gNB 20 is divided in to two by HLS.

CU 21

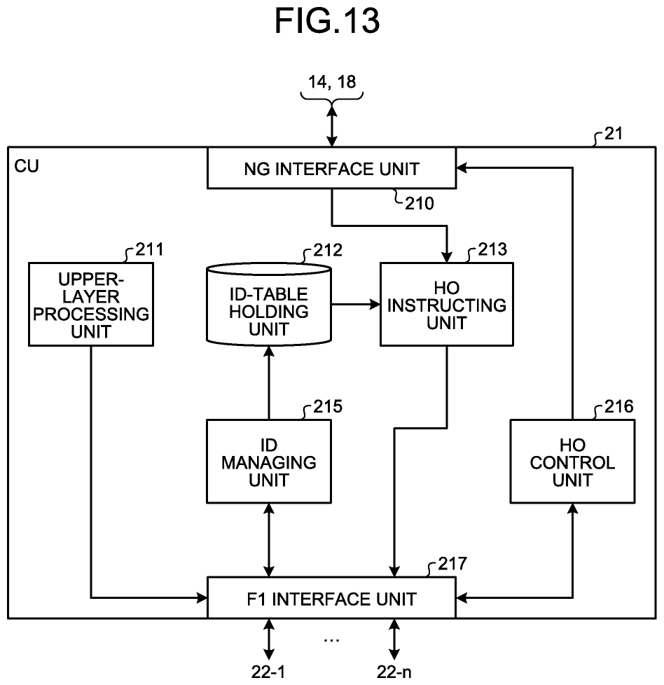

FIG. 13 is a block diagram illustrating an example of the CU 21 in the third embodiment. The CU 21 includes the NG interface unit 210, the upper-layer processing unit 211, the ID-table holding unit 212, the HO instructing unit 213, the ID managing unit 215, the HO control unit 216, and the F1 interface unit 217. In FIG. 13, blocks to which reference symbols identical to FIG. 3 are assigned are similar to the blocks explained in FIG. 3 except a point explained below and, therefore explanation thereof is omitted.

The ID managing unit 215 issues DU_ID with respect to the DU 22, when the F1 interface is established between itself and each of the DUs 22 by the F1 interface unit 217, for each of the DUs 22. The ID managing unit 215 enters the issued DU_ID in an ID table 2120 in the ID-table holding unit 212, associating with information to access the DU 22. Furthermore, the ID managing unit 215 informs the issued DU_ID to the corresponding DU 22 through the F1 interface unit 217.

The upper-layer processing unit 211 generates an RRC signal for each of the DUs 22, and performs processing of the PDCP layer with respect to the RRC signal. The signal subjected to the processing of the PDCP layer by the upper-layer processing unit 211 is one example of a first signal. The upper-layer processing unit 211 outputs the signal subjected to the processing of the PDCP layer to the F1 interface unit 217. The F1 interface unit 217 transmits the signal output from the upper-layer processing unit 211 to the corresponding DU 22.

DU 22

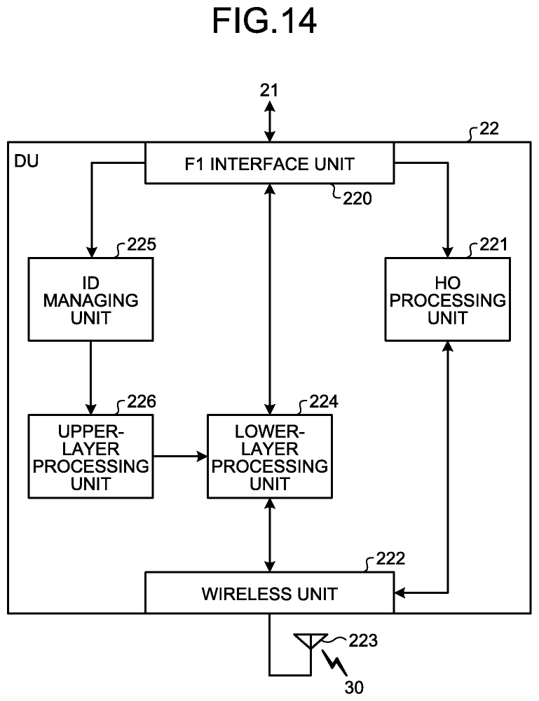

FIG. 14 is a block diagram illustrating an example of the DU 22 in the third embodiment. The DU 22 includes the F1 interface unit 220, the HO processing unit 221, the wireless unit 222, the antenna 223, the lower-layer processing unit 224, a ID managing unit 225, and an upper-layer processing unit 226. In FIG. 14, blocks to which reference symbols identical to FIG. 11 are assigned are similar to the blocks explained in FIG. 11 except a point explained below and, therefore explanation thereof is omitted.

The F1 interface unit 220 outputs DU_ID informed from the CU 21 to the ID managing unit 225. The ID managing unit 225 holes DU_ID output from the F1 interface unit 220. The ID managing unit 225 outputs DU_ID to the upper-layer processing unit 226. The upper-layer processing unit 226 generates a unique RRC signal in which DU_ID output from the ID managing unit 225 is set. The upper-layer processing unit 226 performs processing of the PDCP layer with respect to the unique RRC signal. The upper-layer processing unit 226 then outputs the signal subjected to the processing of the PDCP layer to the lower-layer processing unit 224. The upper-layer processing unit 226 is one example of a generating unit. The signal subjected to the processing of the PDCP layer by the upper-layer processing unit 226 is one example of a second signal.

The lower-layer processing unit 224 receives the signal subjected to the processing of the PDCP layer by the CU 21 through the F1 interface unit 220, and receives the signal subjected to the PDCP layer by the upper-layer processing unit 226. The lower-layer processing unit 224 performs processing of a lower layer with respect to the received signal. In the present embodiment, the lower layer is, for example, the RLC layer and the MAC layer. The lower-layer processing unit 224 outputs the signal subjected to processing of the MAC layer to the wireless unit 222.

Processing of gNB 20

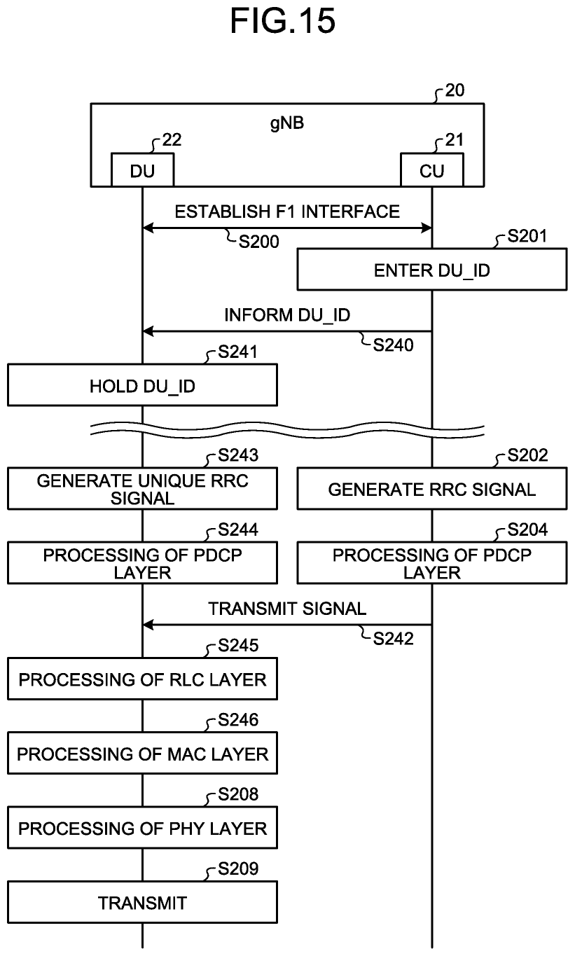

FIG. 15 illustrates an example of processing of the gNB 20 in the third embodiment. FIG. 15 mainly illustrates processing of transmitting a radio signal including DU_ID out of processing of the gNB 20. In FIG. 15, processing to which reference symbols identical to FIG. 8 are assigned are similar to the processing explained in FIG. 8 except a point explained below and, therefore explanation thereof is omitted.

When the F1 interface is established at step S200, the ID managing unit 215 of the CU 21 informs DU_ID issued to the DU 22, to the DU 22 through the F1 interface unit 217 (S240). The F1 interface unit 220 of the DU 22 outputs DU_ID informed by the CU 21 to the ID managing unit 225. The ID managing unit 225 holds DU_ID output from the F1 interface unit 220 (S241). The ID managing unit 225 outputs DU_ID to the upper-layer processing unit 226.

The upper-layer processing unit 211 of the CU 21 generates an RRC signal (S202), and performs processing of the PDCP layer with respect to the RRC signal (S204). The upper-layer processing unit 211 outputs the signal subjected to the PDCP layer to the F1 interface unit 217. The F1 interface unit 217 transmits the signal output from the upper-layer processing unit 211 to the DU 22 corresponding to DU_ID through the F1 interface (S242).

The upper-layer processing unit 226 of the DU 22 generates a unique RRC signal in which DU_ID output from the ID managing unit 225 is set (S243). The upper-layer processing unit 226 performs processing of the PDCP layer with respect to the unique RRC signal (S244). The upper-layer processing unit 226 then outputs the signal subjected to the processing of the PDCP layer to the lower-layer processing unit 224.

The lower-layer processing unit 224 receives the signal subjected to the processing of the PDCP layer by the CU 21 through the F1 interface unit 220, and receives the signal subjected to the processing of the PDCP layer by the upper-layer processing unit 226. The lower-layer processing unit 224 performs processing of the RLC layer with respect to the received signal (S245). The lower-layer processing unit 224 performs processing of the MAC layer with respect to the signal subjected to the processing of the RLC layer (S246). The lower-layer processing unit 224 then outputs the signal subjected to the MAC layer to the wireless unit 222. Thereafter, processing similar to the processing illustrated in FIG. 8 is performed.

### Effect of Third Embodiment

As above, the third embodiment has been described. As described above, the F1 interface unit 220 of the present embodiment receives a first signal including a signal of the RRC layer generated by the CU 21. The upper-layer processing unit 226 generates a second signal including a unique RRC signal in which DU_ID is set. The lower-layer processing unit 224 performs processing of a layer lower than the RRC layer with respect to the first signal and the second signal. The wireless unit 222 transmits a radio signal based on the signal processed by the lower-layer processing unit 224. Thus, the DU 22 is enabled to transmit a radio signal including DU_ID.

### [d] Fourth Embodiment

While DU_ID is set in an RRC signal in the first to the third embodiments described above, DU_ID is set in a signal of the MAC layer in a fourth embodiment. In the present embodiment, a hierarchy of protocol processed in the GNB 20 is divided into two by LLS, and processed in the CU 21 and the DU 22, respectively.

CU 21

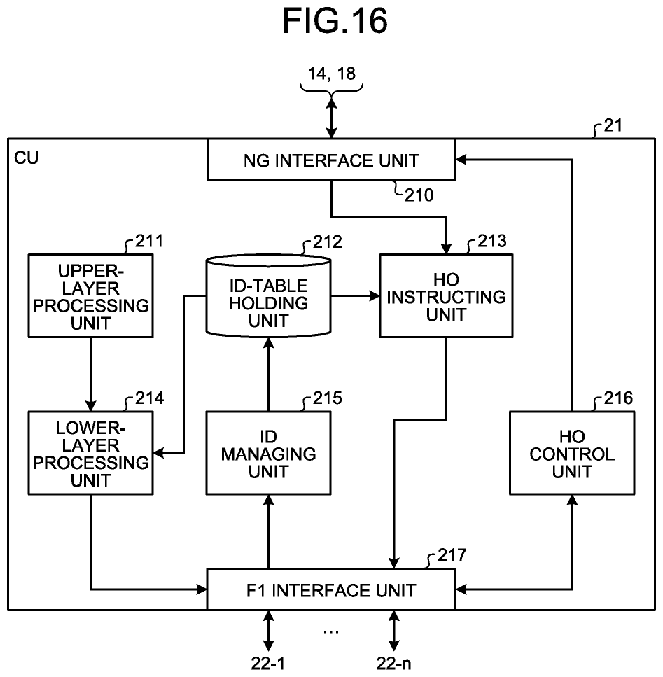

FIG. 16 is a block diagram illustrating an example of the CU 21 in the fourth embodiment. The CU 21 includes the NG interface unit 210, the upper-layer processing unit 211, the ID-table holding unit 212, the HO instructing unit 213, the lower-layer processing unit 214, the ID managing unit 215, the HO control unit 216, and the F1 interface unit 217. In FIG. 16, blocks to which reference symbols identical to FIG. 3 are assigned are similar to the blocks explained in FIG. 3 except a point explained below and, therefore explanation thereof is omitted.

The upper-layer processing unit 211 generates an RRC signal for each of the DU 22, and outputs the RRC signal to the lower-layer processing unit 214. The lower-layer processing unit 214 performs processing of the PDCP layer, the RLC layer, and the MAC layer with respect to the RRC signal output from the upper-layer processing unit 211. The lower-layer processing unit 214 acquires DU_ID unique to the DU 22 from the ID table 2120 in the ID-table holding unit 212, for each of the DUs 22. The lower-layer processing unit 214 sets DU_ID in the signal subjected to the processing of the MAC layer. In the present embodiment, the lower-layer processing unit 214 sets DU_ID to MAC_CE (control element) included in the signal subjected to the processing of the MAC layer. The lower-layer processing unit 214 then outputs the signal in which DU_ID is set to the F1 interface unit 217. The F1 interface unit 217 transmits the signal output from the lower-layer processing unit 214 to the corresponding DU 22.

Because the DU 22 is similar to the DU 22 in the first embodiment explained using FIG. 6, detailed explanation thereof is omitted.

Processing of gNB 20

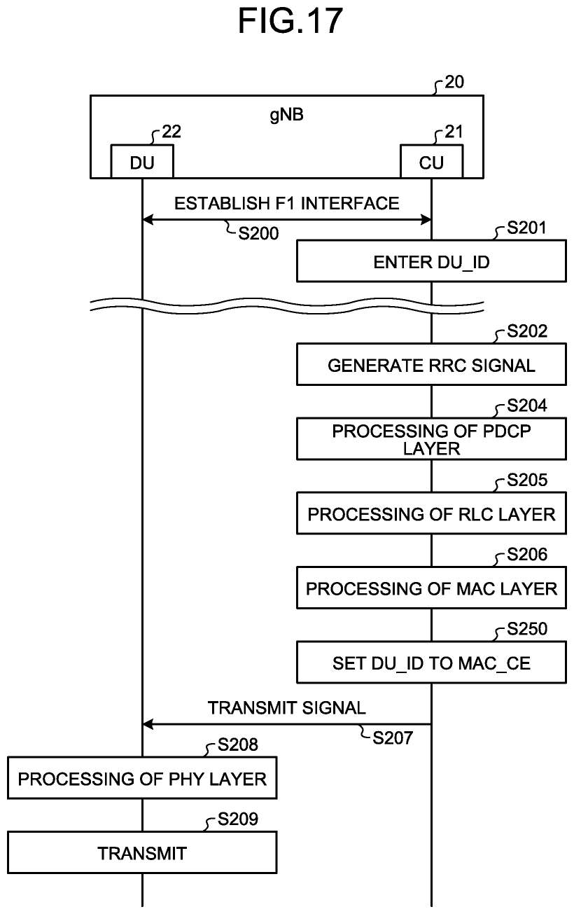

FIG. 17 illustrates an example of processing of the gNB 20 in the fourth embodiment. FIG. 17 mainly illustrates processing of transmitting a radio signal including DU_ID, out of processing of the gNB 20. In FIG. 17, processing to which reference symbols identical to FIG. 8 are assigned is similar to the processing explained in FIG. 8 and, therefore, explanation thereof is omitted.

The upper-layer processing unit 211 of the CU 21 generates an RRC signal (S202), and outputs the RRC signal to the lower-layer processing unit 214. The lower-layer processing unit 214 performs respective processing of the PDCP layer (S204), processing of the RLC layer (S205), and processing of the MAC layer (S206) with respect to the RRC signal.

Next, the lower-layer processing unit 214 acquires DU_ID unique to the DU 22 from the ID table 2120 in the ID-table holding unit 212. The lower-layer processing unit 214 sets DU_ID to MAC_CE included in the signal subjected to the processing of the MAC layer (S250). The lower-layer processing unit 214 then outputs the signal in which DU_ID is set to the F1 interface unit 217. The F1 interface unit 217 transmits the signal output from the lower-layer processing unit 214 to the corresponding DU 22 (S207). Thereafter, processing similar to the processing illustrated in FIG. 8 is performed.

### Effect of Fourth Embodiment

As above, the fourth embodiment has been described. As described above, the F1 interface unit 220 of the present embodiment receives a signal of the MAC layer generated by the CU 21 and including DU_ID. The wireless unit 222 transmits a radio signal based on the signal of the MAC layer received by the F1 interface unit 220. Thus, the DU 22 is enabled to transmit a radio signal including DU_ID.

### [e] Fifth Embodiment

While the CU 21 sets DU_ID in a signal of the MAC layer in the fourth embodiment described above, the DU 22 sets DU_ID in the signal of the MAC layer in the fifth embodiment. In the present embodiment, a hierarchy of protocol processed by the gNB 20 is divided into two by LLS.

CU 21

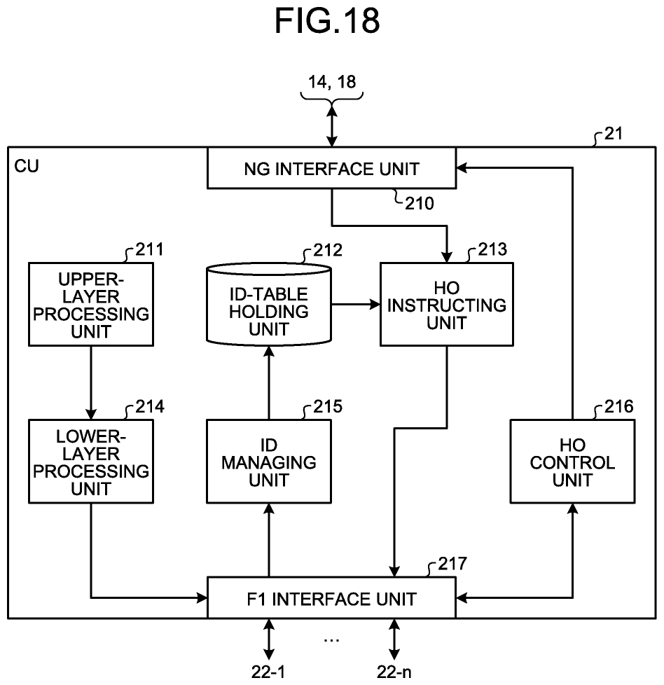

FIG. 18 is a block diagram illustrating an example of the CU 21 in the fifth embodiment. The CU 21 includes the NG interface unit 210, the upper-layer processing unit 211, the ID-table holding unit 212, the HO instructing unit 213, the lower-layer processing unit 214, the ID managing unit 215, the HO control unit 216, and the F1 interface unit 217. In FIG. 18, blocks to which reference symbols identical to FIG. 3 are assigned are similar to the blocks explained in FIG. 3 except a point explained below and, therefore explanation thereof is omitted.

The upper-layer processing unit 211 generates an RRC signal for each of the DU 22, and outputs the RRC signal to the lower-layer processing unit 214. The lower-layer processing unit 214 performs processing of the PDCP layer, the RLC layer, and the MAC layer with respect to the RRC signal output from the upper-layer processing unit 211. The lower-layer processing unit 214 outputs the signal subjected to the processing of the MAC layer to the F1 interface unit 217. The F1 interface unit 217 transmits the signal output from the lower-layer processing unit 214 to the corresponding DU 22.

DU 22

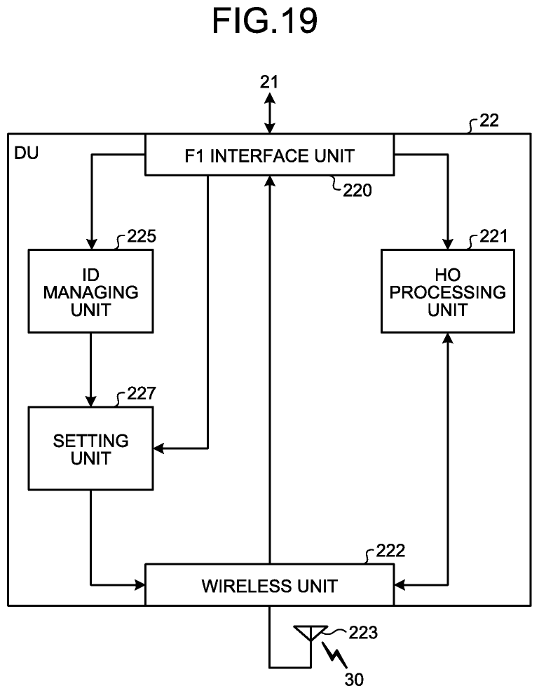

FIG. 19 is a block diagram illustrating an example of the DU 22 in the fifth embodiment. The DU 22 includes the F1 interface unit 220, the HO processing unit 221, the wireless unit 222, the antenna 223, the ID managing unit 225, and a setting unit 227. In FIG. 19, blocks to which reference symbols identical to FIG. 6 are assigned are similar to the blocks explained in FIG. 6 except a point explained below and, therefore explanation thereof is omitted.

The F1 interface unit 220 outputs DU_ID informed from the CU 21 to the ID managing unit 225. The F1 interface unit 220 outputs a signal received from the CU 21 and subjected to the processing of the MAC layer to the setting unit 227. The ID managing unit 225 holds DU_ID output from the F1 interface unit 220. The ID managing unit 225 then outputs DU_ID to the setting unit 227.

The setting unit 227 sets DU_ID output from the ID managing unit 225 to the signal output from the F1 interface unit 220. In the present embodiment, the setting unit 227 sets DU_ID to MAC_CE included in the signal subjected to the processing of the MAC layer. The setting unit 227 then outputs the signal in which DU_ID is set to the wireless unit 222.

Processing of gNB 20

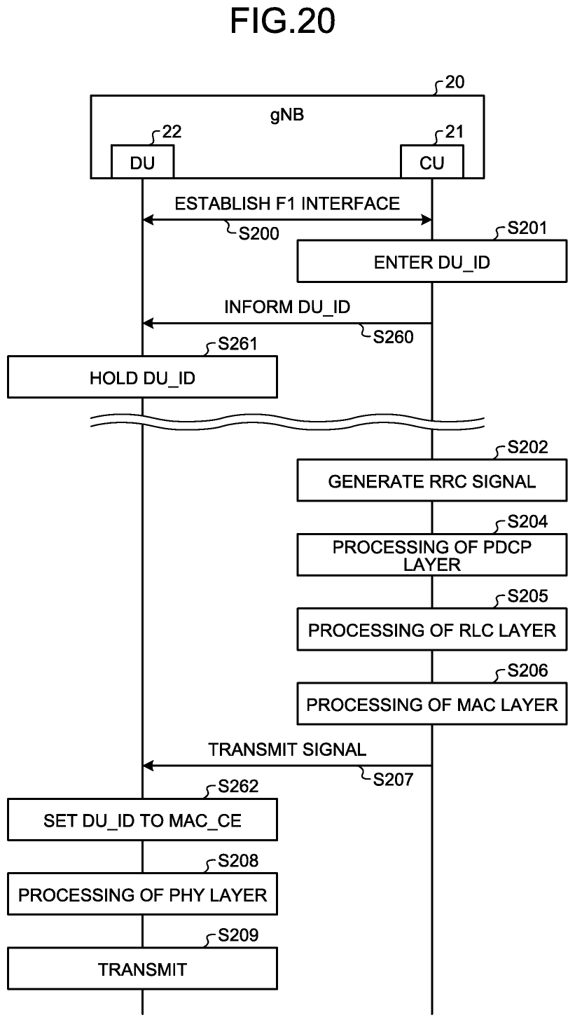

FIG. 20 illustrates an example of processing of the gNB 20 in the fifth embodiment. FIG. 20 mainly illustrates processing of transmitting a radio signal including DU_ID, out of processing of the gNB 20. In FIG. 20, processing to which reference symbols identical to FIG. 8 are assigned is similar to the processing explained in FIG. 8 and, therefore, explanation thereof is omitted.

When the F1 interface is established at step S200, the ID managing unit 215 of the CU 21 informs DU_ID issued to the DU 22, to the DU 22 through the F1 interface unit 217 (S260). The F1 interface unit 220 of the DU 22 outputs DU_ID informed by the CU 21 to the ID managing unit 225. The ID managing unit 225 holds DU_ID output from the F1 interface unit 220 (S261). The ID managing unit 225 outputs DU_ID to the setting unit 227.

The upper-layer processing unit 211 of the CU 21 generates an RRC signal (S202), and outputs the RRC signal to the lower-layer processing unit 214. The lower-layer processing unit 214 performs respective processing of the PDCP layer (S204), processing of the RLC layer (S205), and processing of the MAC layer (S206) with respect to the RRC signal. The lower-layer processing unit 214 outputs the signal subjected to the processing of the MAC layer to the F1 interface unit 217. The F1 interface unit 217 transmits the signal output from the lower-layer processing unit 214 to the corresponding DU 22 (S207).

Next, the F1 interface unit 220 of the DU 22 outputs the signal received from the CU 21, and subjected to the processing of the MAC layer to the setting unit 227. The setting unit 227 sets DU_ID output from the ID managing unit 225 to the signal output from the F1 interface unit 220. Specifically, the setting unit 227 sets DU_ID output from the ID managing unit 225 to MAC_CE included in the signal subjected to the processing of the MAC layer by the CU 21 (S262). The setting unit 227 then outputs the signal in which DU_ID is set to the wireless unit 222. Thereafter, processing similar to the processing illustrated in FIG. 8 is performed.

### Effect of Fifth Embodiment

As above, the fifth embodiment has been described. As described above, the F1 interface unit 220 of the present embodiment receives a signal of the MAC layer generated by the CU 21. The setting unit 227 sets DU_ID to the signal of the MAC layer received by the F1 interface unit 220. The wireless unit 222 transmits a radio signal based on signal of the MAC layer in which DU_ID is set by the setting unit. Thus, the DU 22 is enabled to transmit a radio signal including DU_ID.

### [f] Sixth Embodiment

In the fourth embodiment, the hierarchy of protocol processed by the gNB 20 is divided in to two by LLS. On the other hand, in a sixth embodiment, a hierarchy of protocol processed by the gNB 20 is divided into two by HLS. That is, DU_ID is set to a signal of the MAC layer in the DU 22.

CU 21

Because a configuration of the CU 21 in the present embodiment is similar to the CU 21 in the third embodiment explained using FIG. 13, it is explained referring to FIG. 13. The ID managing unit 215 issues DU_ID with respect to the DU 22, when the F1 interface is established between itself and each of the DUs 22 by the F1 interface unit 217, for each of the DUs 22. The ID managing unit 215 enters the issued DU_ID in an ID table 2120 in the ID-table holding unit 212, associating with information to access the DU 22. Furthermore, the ID managing unit 215 informs the issued DU_ID to the corresponding DU 22 through the F1 interface unit 217.

The upper-layer processing unit 211 generates an RRC signal, and performs processing of the PDCP layer with respect to the RRC signal. The upper-layer processing unit 211 outputs the signal subjected to the processing of the PDCP layer to the F1 interface unit 217. The F1 interface unit 217 transmits the signal output from the upper-layer processing unit 211 to the DU 22.

DU 22

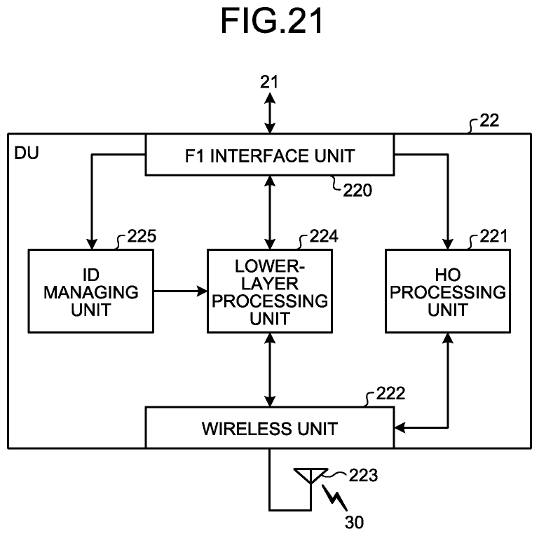

FIG. 21 is a block diagram illustrating an example of the DU 22 in the sixth embodiment. The DU 22 includes the F1 interface unit 220, the HO processing unit 221, the wireless unit 222, the antenna 223, the lower-layer processing unit 224, and the ID managing unit 225. In FIG. 21, blocks to which reference symbols identical to FIG. 6 are assigned are similar to the blocks explained in FIG. 6 except a point explained below and, therefore explanation thereof is omitted.

The F1 interface unit 220 outputs DU_ID informed from the CU 21 to the ID managing unit 225. Moreover, the F1 interface unit 220 outputs the signal received from the CU 21 and subjected to the processing of the PDCP layer to the lower-layer processing unit 224. The ID managing unit 225 holes DU_ID output from the F1 interface unit 220. The ID managing unit 225 outputs DU_ID to the lower-layer processing unit 224.

The lower-layer processing unit 224 performs processing of the RLC layer and the MAC layer with respect to the signal received from the CU 21 through the F1 interface unit 220. The lower-layer processing unit 224 sets DU_ID output from the ID managing unit 225 to the signal subjected to the processing of the MAC layer. In the present embodiment, the lower-layer processing unit 224 sets DU_ID to MAC_CE included in the signal subjected to the processing of the MAC layer. The lower-layer processing unit 224 then outputs the signal in which DU_ID is set to the wireless unit 222. The lower-layer processing unit 224 in the present embodiment is one example of a setting unit. The wireless unit 222 performs processing of the PHY layer with respect to the signal output from the lower-layer processing unit 224. The wireless unit 222 transmits the signal subjected to the processing of the PHY layer to the cell 23 through the antenna 223.

Processing of gNB 20

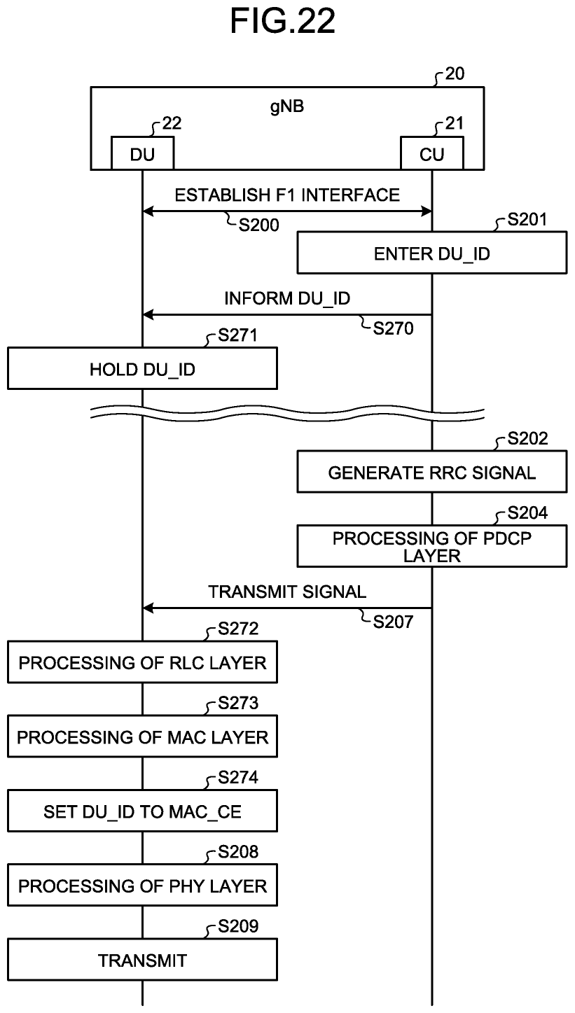

FIG. 22 illustrates an example of processing of the gNB 20 in the sixth embodiment. FIG. 22 mainly illustrates processing of transmitting a radio signal including DU_ID, out of processing of the gNB 20. In FIG. 22, processing to which reference symbols identical to FIG. 8 are assigned is similar to the processing explained in FIG. 8 and, therefore, explanation thereof is omitted.

When the F1 interface is established at step S200, the ID managing unit 215 of the CU 21 informs DU_ID issued to the DU 22, to the DU 22 through the F1 interface unit 217 (S270). The F1 interface unit 220 of the DU 22 outputs DU_ID informed by the CU 21 to the ID managing unit 225. The ID managing unit 225 holds DU_ID output from the F1 interface unit 220 (S271). The ID managing unit 225 outputs DU_ID to the lower-layer processing unit 224.

Moreover, the upper-layer processing unit 211 of the CU 21 generates an RRC signal (S202), and performs processing of the PDCP layer with respect to the RRC signal (S204). The upper-layer processing unit 211 outputs the signal subjected to the PDCP layer to the F1 interface unit 217. The F1 interface unit 217 transmits the signal output from the upper-layer processing unit 211 to the DU 22 corresponding to DU_ID through the F1 interface (S207).

The gNB 20 of the DU 22 receives the signal subjected to the processing of the PDCP layer from the CU 21, and outputs the received signal to the lower-layer processing unit 224. The lower-layer processing unit 224 performs processing of the RLC layer with respect to the signal subjected to the PDCP layer (S272). The lower-layer processing unit 224 then performs processing of the MAC layer with respect to the signal subjected to the processing of the RLC layer (S273). The lower-layer processing unit 224 sets DU_ID to MAC_CE included in the signal subjected to the processing of the MAC layer (S274). The lower-layer processing unit 224 then outputs the signal in which DU_ID is set to the wireless unit 222.

Thereafter, processing similar to the processing illustrated in FIG. 8 is performed.

### Effect of Sixth Embodiment

As above, the sixth embodiment has been explained. As described above, the F1 interface unit 220 of the present embodiment receives a signal of a layer higher than the MAC layer generated by the CU 21. The lower-layer processing unit 224 performs processing of the MAC layer with respect to the signal received by the F1 interface unit 220. Moreover, the lower-layer processing unit 224 sets DU_ID to the signal subjected to the processing of the MAC layer. The wireless unit 222 transmits a radio signal based on the signal in which DU_ID is set by the lower-layer processing unit 224. Thus, the DU 22 is enabled to transmit a radio signal including DU_ID.

Hardware

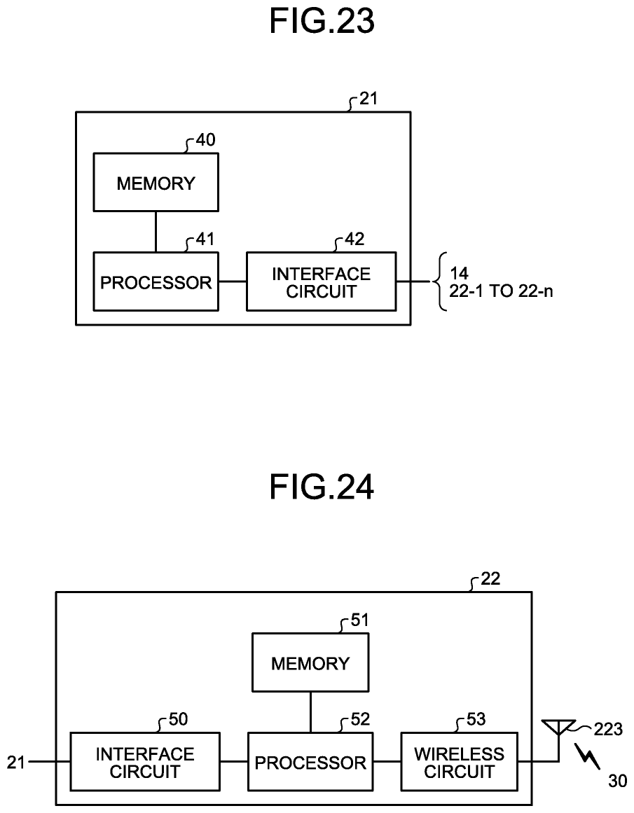

The CU 21 described above is implemented, for example, by hardware as illustrated in FIG. 23. FIG. 23 illustrates an example of the hardware of the CU 21. The CU 21 includes a memory 40, a processor 41, and an interface circuit 42.

The interface circuit 42 performs transmission and reception of a signal between the core network 11 and each of the DUs 22. The interface circuit 42 implements functions of the NG interface unit 210 and the F1 interface unit 217. In the memory 40, various kinds of programs, data, and the like to implement, for example, functions of the NG interface unit 210, the upper-layer processing unit 211, the HO instructing unit 213, the lower-layer processing unit 214, the ID managing unit 215, the HO control unit 216, and a CU 218 are stored. Moreover, in the memory 40, data in the ID-table holding unit 212 is stored. The processor 41 reads a program from the memory 40, and executes the read program, thereby implementing, for example, the respective functions of the CU 21.

The respective programs, data, and the like in the memory 40 are not necessarily stored in the memory 40 from the beginning. For example, the respective programs, data, and the like may be stored in a portable recording medium, such as a memory card inserted into the CU 21, and the CU 21 may read the program, data, or the like from such a portable recording medium, to execute it. Moreover, it may be configured such that the CU 21 acquires the program or the like from another computer or a server device storing the program, data, and the like appropriately through a wireless communication line, a public line, the Internet, a local area network (LAN), a wide area network (WAN), or the like, to execute it.

Moreover, although the memory 40 and the processor 41 are provided one each in the CU 21 illustrated in FIG. 23, two or more each of the memory 40 and the processor 41 may be provided. Furthermore, the CU 21 may be implemented by a part of a computer resource including plural units of the memory 40 and the processor 41.

The DU 22 described above is implemented, for example, by hardware as illustrated in FIG. 24. FIG. 24 illustrates an example of the hardware of the DU 22. The DU 22 includes an interface circuit 50, a memory 51, a processor 52, a wireless circuit 53, and the antenna 223.

The interface circuit 50 is an interface to perform wired communication with the CU 21. The interface circuit 50 implements a function of the F1 interface unit 220. The wireless circuit 53 performs processing of up conversion, and the like with respect to a signal output from the processor 52, and emits the processed signal into the air through the antenna 223. Moreover, the wireless circuit 53 performs processing of down conversion, and the like with respect to a signal received through the antenna 223, and outputs the processed signal to the processor 52. The wireless circuit 53 implements a function of the wireless unit 222.

In the memory 51, for example, various kinds of programs, data, and the like to implement respective functions of the F1 interface unit 220, the HO processing unit 221, the lower-layer processing unit 224, the ID managing unit 225, the upper-layer processing unit 226, and the setting unit 227 are stored. The processor 52 executes a program, or the like read from the memory 51, thereby implementing, for example, the respective functions of the DU 22.

The respective programs, data, and the like in the memory 51 are not necessarily stored in the memory 51 from the beginning. For example, the respective programs, data, and the like may be stored in a portable recording medium, such as a memory card inserted into the DU 22, and the DU 22 may read the program, data, or the like from such a portable recording medium, to execute it. Moreover, it may be configured such that the DU 22 acquires the program or the like from another computer or a server device storing the program, data, and the like appropriately through a wireless communication line, a public line, the Internet, a LAN, a WAN, or the like, to execute it.

Moreover, although the memory 51 and the processor 52 are provided one each in the DU 22 illustrated in FIG. 24, two or more each of the memory 51 and the processor 52 may be provided. Furthermore, the DU 22 illustrated in FIG. 24 may further implement a function of the CU 21.

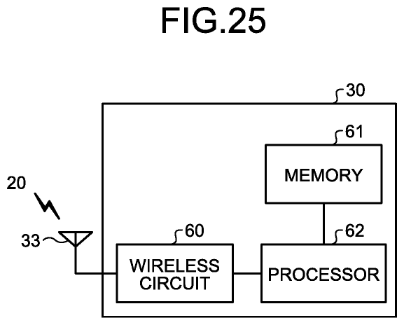

Moreover, the UE 30 described above is implemented, for example, by hardware illustrated in FIG. 25. FIG. 25 illustrates an example of the hardware of the UE 30. The UE 30 includes an antenna 33, a wireless circuit 60, a memory 61, and a processor 62.

The wireless circuit 60 performs processing of up conversion and the like with respect to a signal output from the processor 62, and emits the processed signal into the air through the antenna 33. Moreover, the wireless circuit 60 performs processing of down conversion and the like with respect to a signal received through the antenna 33, and outputs the processed signal to the processor 62. The wireless circuit 60 implements a function of a wireless unit 322.

In the memory 61, for example, various kinds of programs, data, and the like to implement the respective functions of the HO processing unit 31 are stored. The processor 62 executes a program or the like read from the memory 61, thereby implementing, for example, the respective functions of the UE 30.

The respective programs, data, and the like in the memory 61 are not necessarily stored in the memory 61 from the beginning. For example, the respective programs, data, and the like may be stored in a portable recording medium, such as a memory card inserted into the UE 30, and the UE 30 may read the programs, data, or the like appropriately from such a portable recording medium, to execute it. Moreover, it may be configured such that the UE 30 acquires the program or the like from another computer or server device storing the program, data, and the like appropriately through a wireless communication line, a public line, the Internet, a LAN, a WAN, or the like, to execute it. Furthermore, although the memory 61 and the processor 62 are provided one each in the UE 30 illustrated in FIG. 25, two or more each of the memory 61 and the processor 62 may be provided.

Others

The disclosed technique is not limited to the embodiments described above, but various modifications are possible within a range of the gist.

For example, in the respective embodiments described above, when receiving an ID request from the gNB 20, the UE 30 extracts DU_ID from a radio signal received from another gNB 20, and transmits an MR message including extracted DU_ID. However, the disclosed technique is not limited thereto. The UE 30 may extract DU_ID from a radio signal received from another gNB 20, and may transmit an MR message including extracted DU_ID even if an ID request is not received from the gNB 20. Thus, the gNB 20 can handover the UE 30 to the other gNB 20 more swiftly.

Moreover, in the respective embodiments described above, the CU 21 and the DU 22 are explained as separate devices, but the disclosed technique is not limited thereto. The CU 21 and the DU 22 may be implemented, for example, by a computer resource of a single gNB 20 having plural memories and processors, respectively.

Furthermore, in the respective embodiments described above, the respective processing blocks included in the CU 21, the DU 22, and the UE 30 are separated by function according to principal processing, to facilitate understanding of the respective devices in the embodiments. Therefore, the disclosed technique is not limited by a separation method or the names of the processing blocks. Moreover, the respective processing blocks included in the CU 21, the DU 22, and the UE 30 may further be broken down to more processing blocks according to its processing, or plural processing blocks may be integrated into one processing block. Furthermore, a part of or all of the processing performed by each of the processing blocks may be implemented as processing by software, or may be implemented by dedicated hardware, such as application specific integrated circuit (ASIC).

According to one mode of a wireless device, a base station, a terminal device, a wireless communication system, and a communication method disclosed in the present application, handover of a terminal device to a base station that has a DU separated from a CU is enabled.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless device that is provided in a base station including a wireless control device and a wireless device, the wireless device comprising:
a wireless unit that wirelessly transmits a signal including first information to identify an own device in a cell; and
a handover processing unit that performs processing related to handover, when receiving a handover instruction including second information to identify the cell from the wireless control device, with respect to a terminal device in the cell according to the second information included in the handover instruction.

2. The wireless device according to claim 1, further comprising
a signal receiving unit that receives a signal that is generated by the wireless control device, and that includes a signal including a signal of a wireless control layer in which the first information is set, wherein
the wireless unit transmits a radio signal based on the signal received by the signal receiving unit.

3. The wireless device according to claim 1, further comprising:
a signal receiving unit that receives a signal that is generated by the wireless control device and that includes a signal of a wireless control layer in which the first information is set; and
a processing unit that performs processing of a layer lower than the wireless control layer with respect to the signal received by the signal receiving unit, wherein
the wireless unit transmits a radio signal based on the signal processed by the processing unit.

4. The wireless device according to claim 1, further comprising:
a signal receiving unit that receives a first signal that includes a signal of a wireless control layer generated by the wireless control device;
a generating unit that generates a second signal including a signal of the wireless control layer in which the first information is set; and
a processing unit that performs processing of a layer lower than the wireless control layer with respect to the first signal and the second signal, wherein
the wireless unit transmits a radio signal based on the signal processed by the processing unit.

5. The wireless device according to claim 1, further comprising
a signal receiving unit that receives a signal that is generated by the wireless control device, and that includes a signal of a media access control (MAC) layer including the first information, wherein
the wireless unit transmits a radio signal based on the signal received by the signal receiving unit.

6. The wireless device according to claim 1, further comprising:
a signal receiving unit that receives a signal of a MAC layer that is generated by the wireless control device; and
a setting unit that sets the first information in the signal of the MAC layer received by the signal receiving unit, wherein
the wireless unit transmits a radio signal based on the signal of the MAC layer in which the first information is set by the setting unit.

7. The wireless device according to claim 1, further comprising:
a signal receiving unit that receives a signal of a layer higher than the MAC layer that is generated by the wireless control device; and
a setting unit that performs processing of the MAC layer with respect to the signal received by the signal receiving unit, and that sets the first information in the signal subjected to the processing of the MAC layer, wherein
the wireless unit transmits a radio signal based on the signal of the MAC layer in which the first information is set.

8. A base station comprising:
a wireless control device; and
a wireless device, wherein
the wireless device includes
a wireless unit that wirelessly transmits a signal including first information to identify an own device in a cell managed by the wireless device; and
a handover processing unit that performs processing related to handover, when receiving a handover instruction including second information to identify the cell from the wireless control device, with respect to a terminal device in the cell according to the second information included in the handover instruction through the wireless unit, and
the wireless control device includes a handover instructing unit that transmits, when receiving a handover request message including the first information and the second information from a host device, a handover instruction including the second information that is included in the handover request message to the wireless device identified by the first information included in the handover request message.

9. A terminal device comprising:
a receiving unit that receives, from a wireless device included in a first base station, a radio signal including first information to identify the wireless device;
an acquiring unit that acquires the first information from the radio signal; and
a transmitting unit that transmits information regarding the first base station including the first information, to a second base station.

10. A wireless communication system comprising:
a first base station;
a second base station; and
a terminal device, wherein
the first base station includes
a wireless control device; and
a wireless device,
the wireless device includes
a wireless unit that transmits a radio signal including first information to identify an own device in a cell managed by the wireless device; and
a handover processing unit that performs processing related to handover, when receiving a handover instruction including second information to identify the cell from the wireless control device, with respect to the terminal device in the cell according to the second information included in the handover instruction through the wireless unit,
the wireless control device includes
a handover instructing unit that transmits, when receiving a handover request message including the first information and the second information from a host device, a handover instruction including the second information that is included in the handover request message to the wireless device identified by the first information included in the handover request message, and
the terminal device includes
a receiving unit that receives a radio signal transmitted from the first base station;
an acquiring unit that acquires the first information from the radio signal; and
a transmitting unit that transmits information regarding the first base station including the first information, to the second base station.

11. A communication method performed by a wireless device, the method comprising:
transmitting a radio signal including first information to identify an own device in a cell managed by the wireless device; and
performing processing related to handover, when a handover instruction including second information to identify the cell is received from a wireless control device, with respect to a terminal device in the cell according to the second information included in the handover instruction.
